(19) United States
(12) Patent Application Publication
(10) Pub. No.: US 2016/0314287 A1
(43) Pub. Date: Oct. 27, 2016

(54) METHOD FOR GENERATING IMAGES FOR DISTRIBUTION OVER THE INTERNET THAT IDENTIFY THE RECIPIENT IN ORDER TO CONTROL THE REPRODUCTION OF SAID IMAGES, AND THE IDENTIFYING IMAGES OBTAINED

(71) Applicant: IMAGINACIÓN CREATIVA, S.L.U., (Santa Cruz de Tenerife) (ES)

(72) Inventor: José Domingo Fuentes González, (Santa Cruz de Tenerife) (ES)

(21) Appl. No.: 15/106,577

(22) PCT Filed: Dec. 20, 2013
(86) PCT No.: PCT/ES2013/070912

§ 371 Date: Jun. 20, 2016

(51) Int. Cl. G06F 21/16

(52) U.S. Cl. CPC G06F 21/16

(57) ABSTRACT

Method for generating images for distribution over the internet that identify the recipient in order to control the reproduction of said images, comprising the use of software that incorporates identifying marks (4), which include data regarding the user (3) who has received the images, and which remain permanently incorporated from the moment the images are received, said masks appearing superimposed on the different frames (5) in a continuous and randomly variable manner, in terms of opacity, size, number, position and/or frequency, when the images are reproduced. The identifying marks (4) consist of data regarding the IP address of the device of the recipient user (3) and the date and time (UTC) of the connection or of personal data previously provided by the recipient user him/herself. The software that embeds the identifying marks (4) is installed in the device of the transmission centre (2), in the device of the recipient user (3) or in an intermediate server (6) or the software is run from a web page.

### OBJECT OF THE INVENTION

The invention, as exposed on the wording of the present specification, relates to a method for generating images for distribution over the internet that identify the recipient in order to control the reproduction of said images, and to the identifying images obtained by said method.

Particularly, the object of the invention focuses on a method by which images for distribution over the Internet, especially video images, provided with means for controlling their eventual reproduction or redistribution in order to prevent frauds, can be generated, for which said method contemplates the incorporation of identifying marks of the recipient user, usually relating to data of the connection used but not limited thereto, and which by specific software are embedded or superimposed to the continuously and randomly variable transmitted images, such that, if said recipient user tries their reproduction or redistribution, is providing data que that identify him/her against the recipients of the copy.

### APPLICATION FIELD OF THE INVENTION

The application field of the present invention is framed within the field of audio-visual communications, focusing particularly on the field of images broadcasting, distribution and reproduction over the Internet.

### BACKGROUND OF THE INVENTION

As it is known, controlling the improper reproduction of video images broadcast through the Internet is a problem for many of the companies dedicated to their distribution, sin the recipient users, once they receive and capture or download the images, can reproduce or redistribute them without an effective control of who is responsible for said fraudulent reproduction or distribution.

It is then the object of the present invention to provide the market a system allowing to perform said control in a practical and, above all, effective manner, and must be noted that, at least by the applicant the existence of any other method for generating identifying images or invention with a similar application presenting technical characteristics similar to the ones presented the method preconized herein, as claimed, is unknown.

In that regard, it is noteworthy that, although it is known the incorporation of identifying elements on images broadcast by media, for example on TV, the difference to what is proposed here I that said elements are typically intended to identify the author and/or owner of such images and not to identify the responsible for a possible unauthorized reproduction thereof. Furthermore, the identifying elements incorporating said images are restricted exclusively to the incorporation of a mark that remains fixed at a specific point of the image, usually a name or logo of a company or medium author/owner of the images, so it can be relatively easily removed by using appropriate software.

### EXPLANATION OF THE INVENTION

Thus, the method for generating images for distribution over the internet that identify the recipient in order to control the reproduction of said images, and the identifying images obtained proposed by the present invention are configured as a remarkable novelty within its application field, as, according to its implementation and unequivocally the object previously pointed is achieved, being the distinctive characterizing details suitably enclosed in the final claims accompanying the present specification thereof.

Specifically, the invention recommends, as is pointed above, a method contemplating the use of specific software for the incorporation of identifying marks of the recipient user, relating to data of the connection used or other, in the images it receives through the Internet from a transmission centre, which marks are embedded in real time and automatically in the packets of digital data containing the images when said recipient captures them, being permanently incorporated in them from the moment when the recipient receives them, or are superimposed over the video reproduction of the recipient device at the time of displaying, with no need for embedding them in the packets of digital data containing the images.

Anyway, when the recipient of the images reproduces then on its screen or any other, said identifying marks, appear superimposed to the images in a continuous and variable way, both regarding to opacity, size, number, position and frequency, being these variables fully random such that they are unpredictable and, therefore, they are virtually impossible to erase.

As a result, the recommended method is an effective prevention/protection system against unauthorized redistribution of images, primarily focused on preventing the video posted on the Internet from being recorded and distributed without consent of the author.

The proposed method is able to generate images incorporating information allowing the identification of the recipient person thereof. Thus, if the recipient records or captures the images and tries to distribute them, he/she would be providing his/her identity to the recipients of the copy.

Preferably, the identifying marks that are embedded or superimposed on the images correspond to data about the IP address of the recipient plus the date and time (UTC) (Coordinated Universal Time) of the connection, because with said information the recipient can be located.

It should be noted that the proposed method contemplates the use of tools for detecting the use of Proxies, VPNs (Virtual Private Networks), fake IP addresses and other means for hiding the IP address.

The process for embedding or superimposing the identifying marks of the recipient on the images can be performed by installing the software both in the device of the transmission centre of the images, in the device of the recipient user or through an intermediate server, although it can be also run without installation, since it also works in web pages wherein the software code is included in the page itself.

Optionally, the identifying marks of the recipient that are embedded or superimposed over the images can consist of data provided by the recipient user him/herself, for example a telephone number, an identity card number, a customer ID, an email address, etc., for which, however, it must have been a previous registration of the recipient user in the transmission centre as a recognized user in a database created for this purpose.

Finally, it should be noted that, logically, the identifying marks will be discrete and minimally invasive, not to interfere in a disturbing way with the viewing of the video images generated, but still always sufficiently identifiable.

The described method for generating images for distribution over the internet that identify the recipient in order to control the reproduction of said images, y the identifying images obtained by said method represent consequently an innovation with characteristics not known so far for such purpose, reasons which, together with its practical usefulness, grant enough basis to obtain the exclusiveness privilege applied for.

### DESCRIPTION OF THE DRAWINGS

In order to complete the description being made and to ease a better understanding of the characteristics of the invention, we attach to the present specification, making part of the same, a set of layouts where, with an illustrative non limitative character, the following has been represented:

Figure number 1.—Shows a schematic representation of the main elements involved in the method for generating images for distribution over the internet that identify the recipient in order to control the reproduction of said images, object of the invention.

Figure number 2.—Shows a representation of the identifying images obtained by the proposed method, being represented separately an example of three frames of a video reproduction wherein the variant appearance of the identifying marks contemplated by the method of the invention is appreciated.

### PREFERENTIAL EMBODIMENT OF THE INVENTION

In the light of the said figures, and according to their numbering, it can be seen on them that the proposed method, applicable for generating video images (1), transmitted over the Internet (I) from a transmission centre (2), which are identifying the recipient user (3) which receives them, consist of the use of specific software able to incorporate identifying marks (4) of the recipient user, being said marks permanently incorporated from the moment in that the device of the recipient user (3) receives them, appearing in a continuously and randomly variable way, both relating to their opacity or transparency, and/or to their size, and/or to the number of marks appearing at the same time, and/or o the position they occupy in the screen and/or to the frequency with which they appear superimposed on the different frames (5) when said images (1) are reproduced.

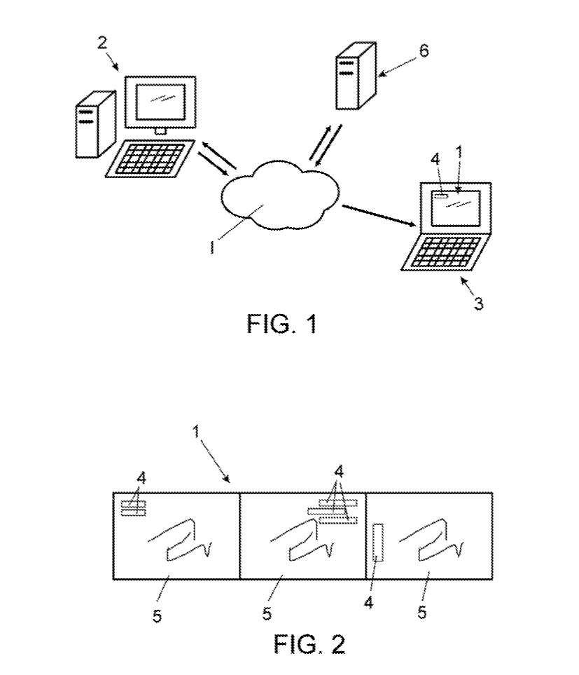

In FIG. 2 can be seen an example of several frames (5) of images of a video generated by the proposed method, with the identifying marks (4) superimposed in changing positions and sizes, as an example of what is described above.

The identifying marks (4) consist of data of the recipient user or of his/her connection and that allow his/her identification or location, being embedded in real time and automatically in the packets of digital data or bits of files containing the images when the device of the recipient user (3) captures them, or being simply superimposed over the video reproduction thereof.

Preferably, the identifying marks (4) are data about the IP address of the device of the recipient user (3) plus the date and time (UTC) of the connection, but optionally, can consist of personal data provided by the recipient user him/herself (3), after registration thereof in the transmission centre (2) as a recognized user o after registration thereof in an intermediate server, application or service.

When the identifying marks (4) include data about the IP address of the device of the recipient user (3), it is additionally contemplated the use of tools for detecting the use of Proxies, VPNs (Virtual Private Networks), fake IP addresses and other means for hiding the IP address. The software that embeds the identifying marks (4) of the recipient on the images (1) is installed in the device of the transmission centre (2) of the images, or in the device of the recipient user (3), or in an intermediate server (6) connecting the transmission centre (2) to the device of the recipient user (3), although it can be also run without installation, since it also works in web pages wherein the software code is included in the page itself.

Having sufficiently described the nature of the present invention, as well as a way of putting it into practice, it is not considered necessary to make a more extensive explanation in order that any expert in this area will understand its scope and the advantages that can be derived from it, making known that, within reason it could be put into practice in other embodiments differing in detail from that indicated by way of example, and which will obtain the same degree of protection, provided that they do not alter, change, or modify its fundamental principle.

1. Method for generating images for distribution over the internet that identify the recipient in order to control the reproduction of said images, particularly applicable for generating video images (1) broadcast over the Internet (I) from a transmission centre (2), which are identifying the recipient user (3) which receives them, characterized in that it comprises the use of specific software that incorporates identifying marks (4), consisting of data that identify or make possible the location of the recipient user (3), being these marks incorporated permanently from the time in that the device of the recipient user (3) receives them, being embedded in real time and automatically in the packets of digital data or bits of files containing the images when the device of the recipient user (3) captures them or superimposed on the video reproduction thereof, appearing superimposed on the different frames (5) in a continuous and randomly variable manner, when they are reproduced.

2. Method for generating images for distribution over the internet that identify the recipient in order to control the reproduction of said images, according to claim 1, characterized in that the identifying marks (4) vary randomly in their appearance regarding to their opacity or transparency.

3. Method for generating images for distribution over the internet that identify the recipient in order to control the reproduction of said images, according to claim 1, characterized in that the identifying marks (4) vary randomly in their appearance regarding to their size.

4. Method for generating images for distribution over the internet that identify the recipient in order to control the reproduction of said images, according to claim 1, characterized in that the identifying marks (4) vary randomly in their appearance regarding to the number of marks appearing at the same time.

5. Method for generating images for distribution over the internet that identify the recipient in order to control the reproduction of said images, according to claim 1, characterized in that the identifying marks (4) vary randomly in their appearance regarding to the position they occupy.

6. Method for generating images for distribution over the internet that identify the recipient in order to control the reproduction of said images, according to claim 1, characterized in that the identifying marks (4) vary randomly in their appearance regarding to the frequency with which they appear.

7. Method for generating images for distribution over the internet that identify the recipient in order to control the reproduction of said images, characterized in that the identifying marks (4) consist of data regarding the IP address of the device of the recipient user (3) plus the date and time (UTC) of the connection.

8. Method for generating images for distribution over the internet that identify the recipient in order to control the reproduction of said images, according to claim 7, characterized in that, when the identifying marks (4) include data about the IP address of the device of the recipient user (3), it is contemplated the use of tools for detecting the use of Proxies, VPNs (Virtual Private Networks), fake IP addresses and other means for hiding the IP address.

9. Method for generating images for distribution over the internet that identify the recipient in order to control the reproduction of said images, according to claim 7, characterized in that the identifying marks (4) consist of personal data provided by the recipient user him/herself (3), after registration thereof in the transmission centre (2) as a recognized user, or after registration thereof in an intermediate server, application or service.

10. Method for generating images for distribution over the internet that identify the recipient in order to control the reproduction of said images, according to claim 7, characterized in that the software that performs the embedding or superimposition of the identifying marks (4) of the recipient user on the images (1) is installed in the device of the transmission centre (2).

11. Method for generating images for distribution over the internet that identify the recipient in order to control the reproduction of said images, according to claim 7, characterized in that the software that performs the embedding or superimposition of the identifying marks (4) of the recipient user on the images (1) is installed in the device of the recipient user (3).

12. Method for generating images for distribution over the internet that identify the recipient in order to control the reproduction of said images, according to claim 7, characterized in that the software that performs the embedding or superimposition of the identifying marks (4) of the recipient user on the images (1) is installed in an intermediate server (6).

13. Method for generating images for distribution over the internet that identify the recipient in order to control the reproduction of said images, according to claim 7, characterized in that the software code that performs the embedding or superimposition of the identifying marks (4) of the recipient user on the images (1) is included in web pages from which it is run.

14. Images for distribution over the internet identificadoras del receptor, obtained according to the generation method thereof as the one described in claim 1, characterized by video images incorporating, superimposed on their frames (5), identifying marks (4) appearing in a continuous and randomly variable way regarding to their opacity, and/or size, and/or number, and/or position and/or frequency.
